(19) United States
(12) Patent Application Publication
(10) Pub. No.: US 2012/0025955 A1
(43) Pub. Date: Feb. 2, 2012

(54) EVENT PROCESSING APPARATUS AND METHODS

(76) Inventors: Colin Henry Balfour, Edinburgh (GB); Lisha Ma, Edinburgh (GB)

(21) Appl. No.: 13/202,846

(22) PCT Filed: Feb. 23, 2010
(86) PCT No.: PCT/GB2010/050312

§ 371 Date: Oct. 10, 2011

Related U.S. Application Data
(60) Provisional application No. 61/154,881, filed on Feb. 24, 2009.

(30) Foreign Application Priority Data
Feb. 23, 2009 (GB) 0903010.7

(51) Int. Cl. H04Q 5/22

(52) U.S. Cl. 340/10.2

(57) ABSTRACT

Event processing apparatus for processing electronic tag reading events comprising a first event processing module and one or more second event processing modules. The or each second event processing module is operable to receive event data records concerning electronic tag reading events from electronic tag readers, and to transmit to the first event processing module processed event data records concerning selected electronic tag reading events. A filter control module transmits filter definitions to the second event processing modules and subsequently transmits filter control signals indicating that filters should be activated or deactivated in order to avoid overloading of the first event processing module. Statistics concerning the selectivity of filters, including filters which are currently inactive, are used to determine which filters should be activated or deactivated.

### FIELD OF THE INVENTION

The invention relates to the field of event processing, particularly the processing of event data records which concern instances of electronic tags being read by electronic tag readers. The event processing apparatus is particularly applicable to circumstances where the volume of event data records to be processed fluctuates over time. In some embodiments, the event processing apparatus is operable to provide responses to queries concerning electronic tag reading events.

### BACKGROUND TO THE INVENTION

The development of electronic tag reading technology, using electronic tag readers which are operable to read data from electronic tags by wireless radio-frequency means, has had a significant impact in many fields of commerce. Wireless electronic tag reading technology facilitates monitoring of the movement of people, such as employees or passengers, or objects, such as inventory items, within a single facility, such as a public space, or factory, or a network of facilities, such as retail outlets and their distribution chains.

Electronic tag reading technology is frequently deployed in circumstances where there will be a substantial volume of electronic tag reading events in which case processing of the resulting electronic tag reading event data records presents a significant technical challenge. Data processing is rendered even more difficult where the volume of electronic tag reading events, and therefore electronic tag reading event data records, fluctuates over time. In these circumstances, one option is to provide sufficient computing resources to process event data records received at the maximum anticipated rate. However, this can result in unnecessary cost, with computing resources being under-utilised for much of the time.

U.S. 2006/0143439 (Arumugam et al.) discloses a method and system for sensor data management in which intelligent data routers execute application level logic encapsulating business rules to make real-time enterprise data decisions and execute business transactions. Data routers can execute application level logic, which may be relatively complex, and so the system remains costly to implement, and not especially suited to the cost-effective processing of fluctuating high volumes of electronic tag reading event data records.

U.S. 2007/0265866 (Oracle) discloses a method and system for managing sensor data in a computer database environment which avoids the propagation of data resulting from all sensor reading events to all software applications which require information resulting from sensor reading events. However, rather than forwarding electronic tag reading event data records, software applications are notified of state changes, determined using an operational environment model. Thus, the initial processing of electronic tag reading event data records is relatively complex, requiring substantial computational resources if a high volume of electronic tag reading event data records is received, and as state changes are forwarded rather than electronic tag reading event data, not all electronic tag reading event data is readily available for downstream processing.

Accordingly, the present invention aims to provide improved electronic tag reading event data processing apparatus, suitable for processing large and fluctuating quantities of electronic tag reading event data records, in a cost-effective and reliable fashion. Preferred embodiments of the invention are operable to receive and process event data records resulting from the reading of electronic tags of a variety of types, and to work with known standards for event processing. Some embodiments of the invention are operable to respond to queries and to amend their functionality depending on a received query.

### SUMMARY OF THE INVENTION

According to a first aspect of the present invention there is provided event processing apparatus for processing electronic tag reading events, the apparatus comprising a first event processing module and one or more second event processing modules, the or each second event processing module being operable to receive event data records concerning electronic tag reading events from electronic tag readers, and to transmit to the first event processing module processed event data records concerning selected electronic tag reading events.

According to a second aspect of the present invention there is provided a method of processing electronic tag reading events, the method comprising the steps of receiving event data records concerning electronic tag reading event at a second event processing module from electronic tag readers, and transmitting processed event data records concerning selected electronic tag reading events to a first event processing module.

Preferably, the or each second event processing module is operable to transmit processed event data records concerning electronic tag reading events selected according to one or more active selection criteria. Active selection criteria may include positive criteria which determine which electronic tag reading events are selected. Active selection criteria may include negative criteria which determine which electronic tag reading events are not selected.

Preferably, the one or more said active selection criteria are changeable over time. The event processing apparatus may comprise a filter control module operable to determine some or all of the active selection criteria used to select electronic tag reading events at a given time. It may be that, in some circumstances, all electronic tag reading events are selected and transmitted to the first event processing module and, in some other circumstances, only some of the received event data records are transmitted to the first event processing module. It may be that, in a default mode, all received event data records are selected and that only some of the received event data records, as determined by active selection criteria, are selected in some operating conditions. Thus, load shedding may occur during only some operating conditions.

The filter control module is preferably operable to determine some or all of the active selection criteria taking into account a current or predicted future load of electronic tag reading events. Preferably, the filter control module is operable to determine some or all of the active selection criteria to prevent the current or predicted future load of processed event data records transmitted to the first event processing module exceeding a predetermined amount. Thus, event data records can be shed at the one or more second event processing modules to avoid overloading the first event processing module.

The current or predicted future load of electronic tag reading events taken into account by the filter control module may be one or more of a group comprising: the current rate of receipt of event data records at one or more second event processing modules, the current rate of receipt of processed event data records at the first event processing module, a predicted future rate of receipt of event data records at one or more of the second event processing modules, a predicted future rate of receipt of processed event data records at the first event processing module; the size of received event data records, and the selectivity of one or more filter criteria.

In order to predict a future load of electronic tag reading events, the filter control module may take into account statistics of historical loads of electronic tag reading events. The historical event data record receipt statistics may be derived from records concerning event data records or processed event data records received by or processed by either or both of the first and second event processing modules. Thus, the event processing apparatus is preferably operable to record data concerning volumes of received event data records.

The filter control module may also take into account processing being carried out by the first event processing module in order to determine some or all of the active selection criteria used to select electronic tag reading events at a given time. The rate at which the first event processing module can receive electronic tag reading events may vary depending on the computational requirements of the event processing currently being carried out by the first event processing module and/or an amount of memory currently available to the first event processing module.

The filter control module may be operable to transmit filter control signals to one or more said second event processing modules, and the or each said second event processing module may be operable to vary the active selection criteria used to select electronic tag reading events responsive to received filter control signals.

The filter control module may be operable to transmit filter definitions to one or more said second event processing modules. Preferably, some or all of the active selection criteria used by the or each second event processing module to select electronic tag reading events are determined by filter definitions previously received by the respective second event processing module. The filter definitions may specify identifiers associated with electronic tags, for example, identifiers of electronic tags, or identifiers of persons or objects with which electronic tags are associated. The filter definitions may comprise queries and the one or more second event processing modules may be operable to query one or more databases, for example to determine identifiers associated with electronic tags or properties of electronic tags, which may be relevant to determining whether a received event data records should be selected. The resulting lists may be used, for example as look-up tables, when selecting electronic tag reading events. Filter definitions may comprise SQL queries.

In a preferred embodiment, the filter control module is operable to transmit filter definitions to the one or more said second event processing modules and to subsequently transmit filter control signals to the one or more said second event processing modules, the said filter control signals being indicative that one or more filter criteria determined by a previously transmitted filter definition should be activated or deactivated, wherein the or each second event processing module is operable to include one or more criteria determined by a previously received filter definition in the one or more active selection criteria, or to remove one or more criteria determined by a previously received filter definition from the one or more active selection criteria, responsive to a filter control signal indicating that one or more filter criteria determined by the respective previously transmitted filter definition should be activated or deactivated, as appropriate.

Filter definitions may be processed in order to provide the one or more active selection criteria. For example, it may be that a plurality of filter definitions which are currently active would determine that the same electronic tag reading event should be selected and so, in order to unnecessary computational steps, when one of the said plurality of filter definitions is activated, the one or more active selection criteria may be modified only by include one or more criteria which cause electronic tag reading events which would not by selected on the basis of the already active selection criteria to be introduced to the one or more active selection criteria.

Thus, the filter control module need not transmit a full definition of the one or more active selection criteria to one or more said second event processing modules every time that the control module determines that the one or more active selection criteria should be changed. Instead, filter definitions can be transmitted to one or more second event processing module and then one or more criteria determined by the filter definitions can be included into or removed from the one or more active selection criteria applied by a said second event processing module responsive to subsequent filter control signals from the filter control module. This substantially reduces the volume of data communication required between the filter control module and the one or more second event processing modules in use, conserving bandwidth and computing resources for the task of processing event data records.

The one or more second event processing modules are preferably operable to transmit filter matching data related to the proportion of received event data records which match the one or more criteria of a previously received filter definition to the filter control modules. The filter matching data is preferably related to the selectivity of a previously received filter definition, that is to say, the proportion of received event data records which are to be forwarded to the first event processing module according to a respective previously received filter definition. (In embodiments where the filter definitions specify negative criteria, the event data records which are to be forwarded to the first event processing module are those which are not encompassed by the negative criteria. Where, as is typical, the filter definitions specify positive criteria, the event data records which are to be forwarded to the first event processing module are those which are encompassed by the positive criteria). The filter matching data might be related to the rate of receipt of events data records which fulfil the one or more criteria of the respective previously received filter definition.

The one or more second event processing modules may be operable to transmit said filter matching data in connection with one or more filter definitions which are currently active. This enables the filter control module to determine the effect on the rate at which processed event data records are received by the first event processing module of deactivating one or more filter definitions.

Preferably, the one or more second event processing modules is operable to transmit said filter matching data in connection with one or more filter definitions which are currently inactive. This enables the filter control module to determine the effect on the rate at which processed event data records are received by the first event processing module of activating one or more currently inactive filter definitions. Thus the filter matching data enables the filter control module to take into account event data records which are received by one or more of the second event processing modules but not forwarded to the first event processing module.

The ability of the one or more second event processing modules to measure the selectivity of filter definitions facilitates the control of the second event processing modules to optimise the performance of the event processing apparatus.

Preferably, the event processing apparatus is operable to receive and respond to queries concerning electronic tag reading events or data derived from electronic tag reading events processed by the event processing apparatus. Typically, the first event processing module is operable to respond to said queries.

Typically, the filter control module is operable to transmit filter control signals to one or more second event processing modules responsive to receipt of a query by the event processing apparatus. Preferably, the filter control module is operable to transmit filter definitions to one or more second event processing modules responsive to receipt of a query by the event processing apparatus. More preferably, the event processing apparatus (typically, the first event processing module) is operable to create one or more filter definitions responsive to the receipt of a query and to transmit one or more filter definitions which are created as a result to one or more second event processing modules. This enables the event processing apparatus to dynamically change the basis on which electronic tag reading events are selected by the second event processing modules, responsive to a query. Where the filter control module (and thus the or each second event processing module) is also responsive at least in part to a current or predicted future load of electronic tag reading events, the way in which the filter control module (and thus the or each second event processing module) responds to a current or predicted future load of electronic tag reading events is therefore changeable in response to a received query.

The or each second event processing module may be operable to select an electronic tag reading event responsive to an identifier included in the received event data record concerning the respective electronic tag reading event. The identifier may be a unique identifier of the electronic tag which the electronic tag reading event concerns. This is computationally efficient as fewer computing resources are typically required to determine whether a received event data record concerns the reading of an electronic tag having a given unique identifier than would be required to determine whether the electronic tag reading event data record fulfils more complex criteria.

Thus, the or each second event processing module may be operable to store identifiers of electronic tags which fulfil received filter definitions. For example, a group of identifiers of electronic tags may be stored responsive to an individual received filter definition. Thus, the or each second event processing module may be operable to determine whether or not to select an electronic tag reading event by comparing a unique identifier of the electronic tag in the received event data records with a list of identifiers, either as the first step of a multi-step filtering process, or as the sole filtering step.

Some or all of the filter definitions may comprise identifiers of electronic tags, or data from which identifiers of electronic tags can be determined by the or each second event processing module. Where the filter definitions comprise queries, the or each second event processing module may be operable to determine identifiers of electronic tags, or people or objects associated with electronic tags, which may meet criteria specified in received queries.

The filter control module may be operable to output filter definitions comprising identifiers of electronic tags, or data from which identifiers of electronic tags can be determined by the or each second event processing module, which electronic tags may be required to respond to a query. Thus, the event processing apparatus may comprise a query processing module operable to determine identifiers of electronic tags which might meet criteria specified in a query. This enables the or each second event processing module to select electronic tag reading events which might be required to respond to a particular query.

The filter control module is preferably integral to the first event processing module. This enables the filter control module to more readily respond to the current activity level of the first event processing module. Nevertheless, the filter control module may be separate to the first event processing module, or distributed between a plurality of processors.

The processed event data records which are transmitted to the first event processing module may be selected received event data records, for example selected received event data records which are unmodified or changed only in terms of format.

However, the output processed event data records may be modified received event data records which include different data to the received event data records. Thus, the second event processing module may comprise an event data record modification module. For example, the processed event data records may comprise some or all of the data in a received event data record concerning an instance of an electronic tag being read, enriched to include additional data. Thus, the event data record modification module preferably comprises or consists of an event data record enrichment module. Data may be removed, edited, added and/or reformatted by the event data record enrichment module. The event data record enrichment module is preferably operable to output processed event data records including some or all of the data in the respective received event data records and one or more additional data. Preferably, the event record data modification module is in communication with one or more databases including data relevant to electronic tags, such as data concerning an article, or a person, with whom an electronic tag is associated. This data can be used to modify (preferably enrich) received event data records. Data from the said one or more databases, for example, one or more identifiers of an article, or a person, with whom a respective electronic tag is associated, may be part or all of the said additional data included in processed event data output by the event data record enrichment module. Thus, the data record enrichment module may be operable to enrich event data records with data concerning a person or item with which an electronic tag is associated, which data is required to respond to one or more queries.

More preferably, the event data record modification module comprises an event data record translation module operable to modify the event record data by replacing one or more data. The translation module may be operable to determine from the identifier of an electronic tag included in the event record data, an identifier of a person or object with which the electronic tag is associated, and to add an identifier of the person or object to the event record data. This is advantageous as this is a rapid data processing step which can be carried out, for example, with reference to a table, which enables subsequent data processing to take into account an identifier of the person or object with which the tag is associated rather than simply an identifier of the electronic tag.

It may be that the one or more second event processing modules select electronic tag reading events before modification and then modify selected event data records, at least in some circumstances. However, it may be that, in at least some circumstances, the one or more second event processing modules select electronic tag reading events after modification (typically after enrichment, e.g. translation) according to one or more criteria which require data introduced into the event data records during modification. Preferably, the one or more second event processing modules select electronic tag reading events responsive to an identifier of a person or object with which an electronic tag is associated, introduced into an event data record by an event data record modification module.

The event processing apparatus may have an operating mode in which only a proportion (i.e. a fraction less than unity) of events which fulfil one or more active selection criteria (for example, one or more queries) are selected, wherein the first event processing module is operable to determine an estimated number of event data records received by the event processing apparatus which fulfil a query from the number of processed event data records which fulfil a query and from the said proportion. The first event processing module may communicate the said proportion to one or more of the second event processing modules. The one or more second event processing modules may communicate the said proportion to the first event processing module.

The first and second event processing modules are typically separate computing devices, and typically connected by a network. The electronic tag readers may communicate with the second event processing modules across the same network. The electronic tag readers are typically operable to read electronic tags wirelessly.

According to a third aspect of the present invention there is provided computer program code which, when executed on one or more computers, causes the one or more computers to function as the event processing apparatus of the first aspect of the invention, or to carry out the method of the second aspect of the invention.

Computer program code may be stored on a computer readable storage medium, for example, a ROM, PROM, EPROM, EEPROM, flash memory device, optical disc (such as a CD or DVD), or an electromagnetic storage device such as a magnetic tape, floppy disc or a hard drive. Computer program code may be conducted by carrier, which may be a transmissible carrier such as an electrical or optical signal which may be conveyed via electrical or optical cable, by radio frequency wireless transmission or by other means. The transmissible carrier may be a cable. Computer program code may be provided in the form of source code, object code or a code intermediate source, such as in partially compiled form, or any other suitable form.

### DESCRIPTION OF THE DRAWINGS

An example embodiment of the present invention will now be illustrated with reference to the following Figures in which:

FIG. 1 is a schematic diagram of event processing apparatus according to the invention;

FIG. 2 is a schematic diagram of components of the event processing apparatus of FIG. 1;

FIG. 3 is a schematic diagram of an RFID tag;

FIG. 4 is a schematic diagram of an edge engine;

FIG. 5 is a schematic diagram of the event engine; and

FIG. 6 is a schematic diagram of data flow between an event engine, an edge engine and an electronic tag reader.

### DETAILED DESCRIPTION OF AN EXAMPLE EMBODIMENT

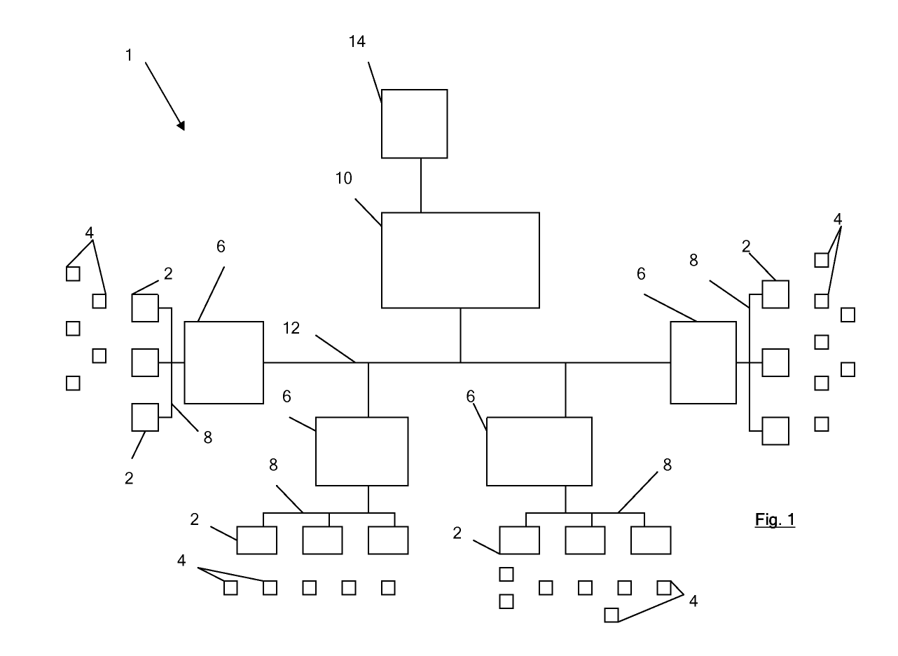

An example embodiment of the invention will now be illustrated with reference to FIG. 1 which is a schematic diagram of event processing apparatus shown generally as 1. The event processing apparatus comprises a plurality of electronic tag readers 2, operable to read data from electronic tags 4 and generate electronic tag reading event data records. The electronic tag readers include wireless electronic tag readers operable to read data from electronic tags commonly referred to as radio-frequency identification tags (RFID tags), and the event processing apparatus may include electronic tag readers operable to read data from electronic tags in different formats, for example both tag readers for reading passive electronic tags (such as RFID tags according to the Generation 2 Electronic Product Code (EPC) format) and tag readers for reading Wi Fi-based active tags.

The electronic tag readers are in electronic communication with computing devices referred to herein as edge engines 6, which function as second event processing modules, to which they transmit electronic tag reading event data records across wired or wireless networks 8. Electronic tag readers are typically spaced apart through a facility or group of facilities and groups of electronic tag readers which are relatively close to each other transmit electronic tag reading event data records to the same edge engine.

The edge engines are operable to process and filter electronic tag reading event data records, as discussed further below, and to transmit selected processed event data records to a complex event processing engine 10, which functions as the first event processing module, across a further wired or wireless network 12. The complex event processing engine is operable to process the event data records which it receives and, amongst other functionality, provides responses to queries received from a user by way of a user interface 14.

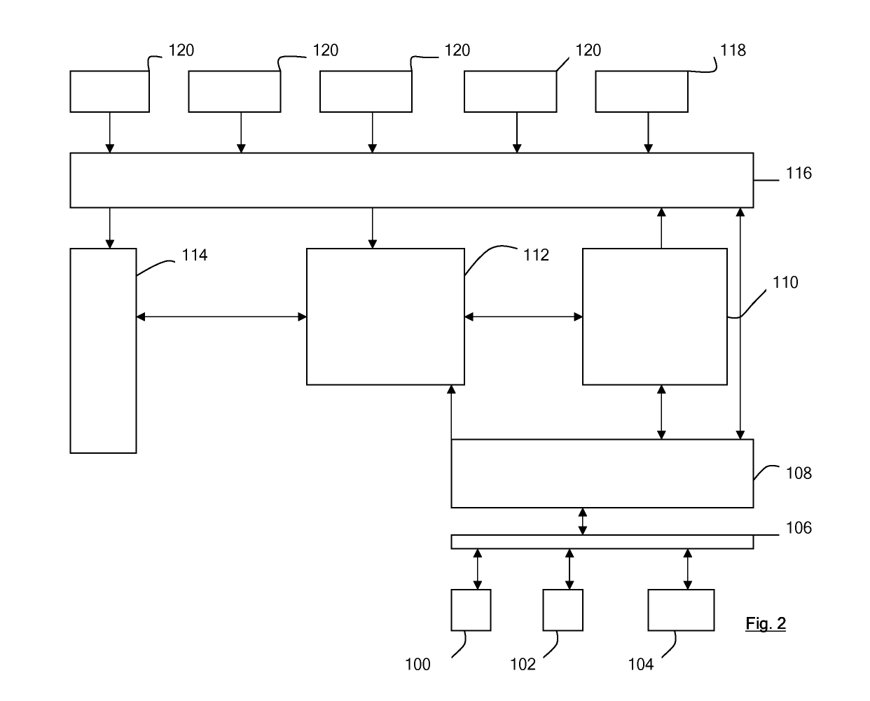

FIGS. 2 through 5 are schematic diagrams of software components of the event processing apparatus as a whole, electronic tags, an edge engine and the event engine respectively. Events data records are generated initially by electronic tag readers executing electronic tag reader control software. For example, RFID readers execute RFID control software 100 which generates RFID reading event data records and Wi-Fi tag readers executes Wi-Fi reader control software 102 which generates Wi-Fi tag reading event data records. Simulation software 104 which generates electronic tag reading event data records may be employed for the purposes of testing the event processing apparatus, or during a design phase prior to installation of the event processing apparatus.

Electronic tag reading event data records generated from these several sources are each processed by an application level event processing layer (ALE) 106 which can be implemented, for example, using LogicAlloy ALE, Java-based RFID-EPC compliant RFID middleware software available from SourceForge (http://sourceforge.net/projects/logicalloy/). (logicAlloy is a trade mark of logicAlloy, Inc., SourceForge is a trade mark of SourceForge, Inc., Java is a trade mark of Sun Microsystems, Inc.). The use of an ALE enables events from disparate sources to be subsequently processed in a consistent format and the use of a commonly accepted open source facilitates interoperability. The program code required to implement the application level event process layer can, for example, be executed on individual event engines.

Electronic tag reading event data records are forwarded to the respective edge engine by the ALE and components of the edge engine software 108 are described further below. Processed event data records concerning selected electronic tag reading events are forwarded to the event engine. Components of the event engine software 110 are also discussed below.

The edge engine control software and event engine software are in communication with complex event processing (CEP) layer 112 executing applications and services such as the Coral8 event processing platform, Apama event processing platform, StreamBase event processing platform, Aleri streaming platform, or Esper or NEsper event processing engine. (Coral8, Apama, StreamBase, Esper and Aleri are trade marks of Coral8, Inc., Progress Software Corporation, StreamBase Systems, Inc., and Aleri Group Inc., respectively. Esper and NEsper are trade marks of Esper Tech Inc.). This enables the event processing apparatus to be integrated with third party applications and legacy systems.

The complex event processing layer is in communication with databases 114 using database interfaces such as Oracle, Sybase, SQL Server and MySQL. (Oracle is a trade mark of Oracle Corporation, Sybase is a trade mark of Sybase, Incl., SQL server is a trade mark of Microsoft Corporation, MySQL is a trade mark of Sun Microsystems, Inc.) The databases may include a wide range of data relative to the task for which the event processing apparatus is intended. Typically, the databases will include data associating identifiers of electronic tags with identifiers of people or objects with which the electronic tags are associated.

Event abstraction layer 116 provides communication between the databases, CEP layer, event engine, edge engines and interfaces including an interface with event engine manager graphic user interface 118 and third party business process management software such as Microsoft BizTalk Server, WebSphere, BEA business process management software, OFBIZ and so forth. (Microsoft BizTalk Server is a trade mark of Microsoft Corporation, BEA is a trade mark of Oracle Corporation, WebSphere is a trade mark of IBM Corporation, OFBIZ is a trade mark of the Apache Software Foundation.)

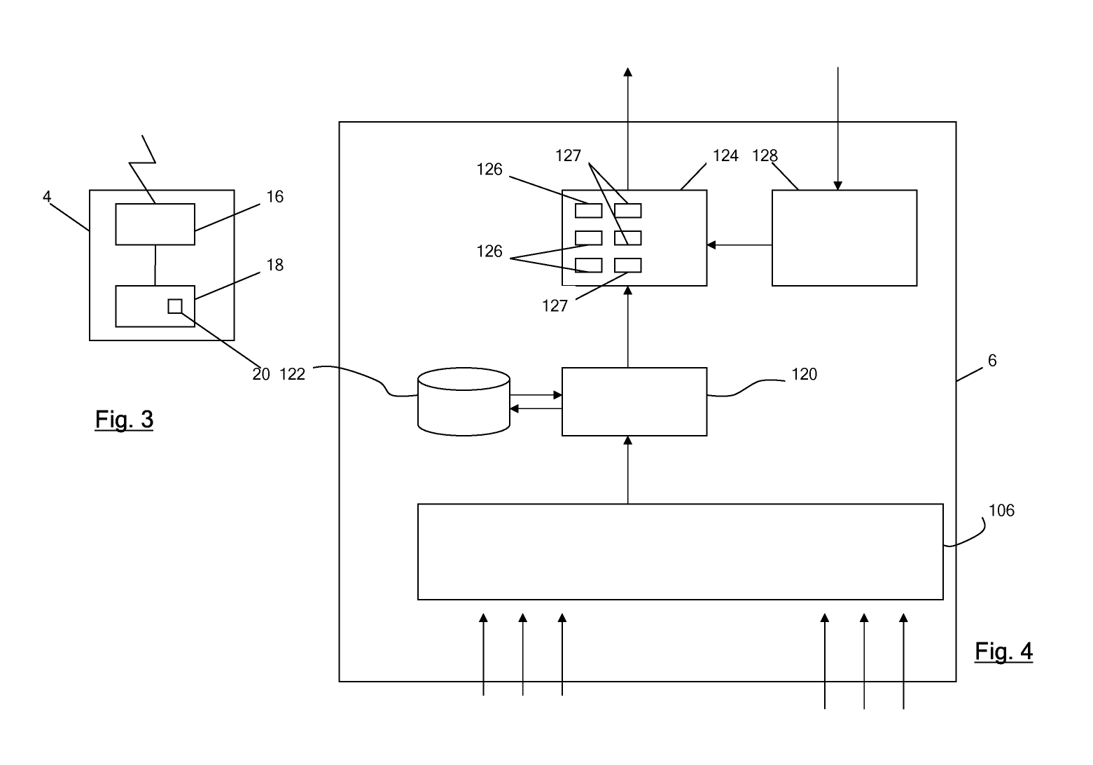

With reference to FIG. 3, an electronic tag for use with the invention includes a radio-frequency transceiver 16, such as an induction loop in communication with a memory device 18 storing at least a unique identifier 20 of the tag. Electronic tags may be passive, active or semi-passive and one skilled in the art will appreciate that many types of electronic tag could be employed, including those with hard-wired memory for storing a unique identifier, write-once memory, rewritable memory and/or integrated sensors.

FIG. 4 is a schematic diagram of key functional components of an edge engine. The application event layer receives electronic tag reading event data records from electronic tag readers. Event data records are forwarded to a translator module 120. The translator module is operable to modify the event data records, where appropriate, by adding additional data, deleting data or replacing data within the event data records as appropriate, with reference to translation data 122, such as a table listing electronic tag identifiers and identifiers of persons or objects recorded as being associated with the electronic tag having the corresponding identifier. Translation data is typically received by the edge engine from the databases 114, typically indirectly via the event engine.

The translator module forwards event data records to a filter module 124. The filter module stores a plurality of filter definitions 126. In this example, the filter definitions comprise queries which can be resolved to determine whether an event data record should be forwarded to the event engine. Each filter definition is associated with a list of identifiers 127 of electronic tags, or people or objects associated with electronic tags, which might fulfill the respective filter definition. The procedure for obtaining the lists of identifiers is set out below. The filter definitions are received from a feedback handler module 128. The feedback handler module also receives filter control signals indicating that filters should be activated or deactivated and forwards these control signals to the filter module.

At any given time, the set of filters which are currently activated together determine which event data records should be forwarded to the event engine. Together, they constitute some or all of the one or more active selection criteria. Event data records concerning electronic tag readings events which fulfil the one or more active selection criteria are forwarded to the event engine.

As the filter module stores lists of identifiers of electronic tags which fulfill the criteria determined by previously received filter definitions, filter definitions can be evaluated in use with reference only to the lists of identifiers, thereby speeding up processing.

The filter module may determine whether an event data record should be forward using identifiers which were originally received directly from electronic tags, for example, unique identifiers of respective tags. However, the identifiers which the filter module compares with one or more lists of identifiers may be identifiers which were included in the event data records for the first time by the translator module. For example, they may be identifiers of people or objects with which a respective electronic tag is known to be associated. This enables the filter modules to carry out selection using identifiers of relevant people or objects, without the additional computational step of determining the identifier of the electronic tag associated with the respective person or object.

The translators may introduce additional data into event data records which may be useful to the filter module or, at useful to the event engine later in the data processing pipeline. For example, the translator module may have access to a database of the location of electronic tag readers and may introduce the location of the electronic tag reader which read an electronic tag to generate an electronic tag reading event into event data records. This may be useful to the event engine and may alternatively or additionally be used by the filter module which may filter event data records taking into account the location where the electronic tag reading event which that event data record concerns took place.

As well as filtering received event data records and only forwarding event data records fulfilling the definition of one or more filters, the filter module also measures the selectivity of each filter, including filters which are currently deactivated. By ‘selectivity’ we refer to the proportion of received event data records which fulfill the one or more criteria as to which event data records should be forwarded as defined by a filter definition. The resulting metrics are transmitted to the event engine filter control module (described further below) to provide additional information to better enable the rate of receipt of event data records by the event engine to be regulated.

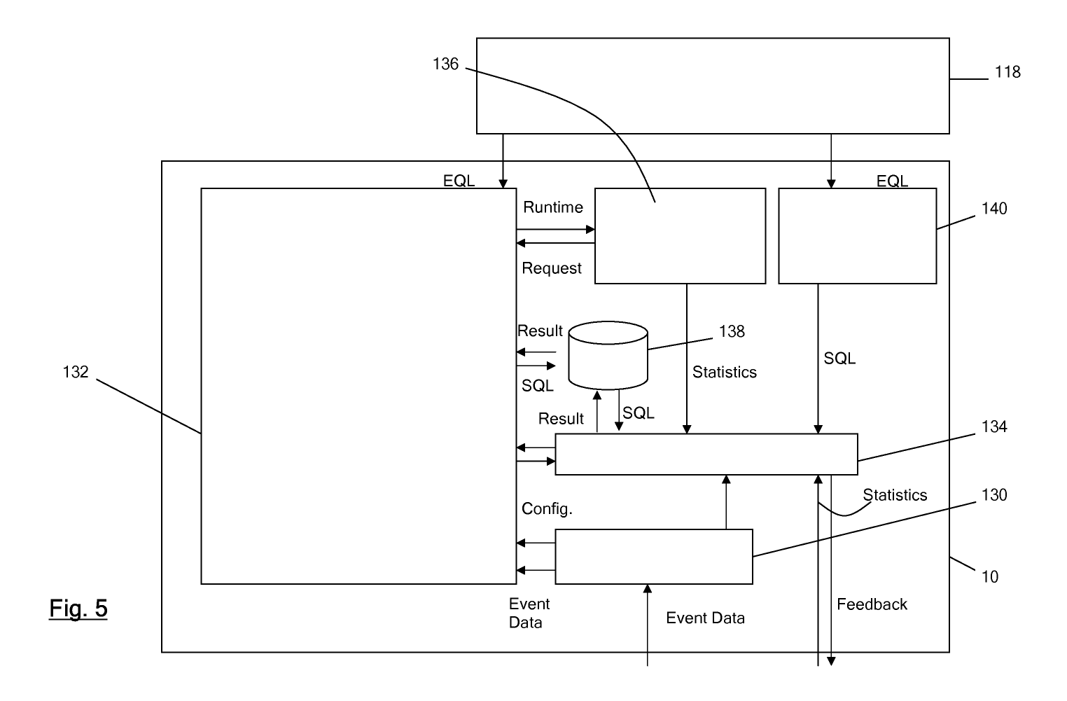

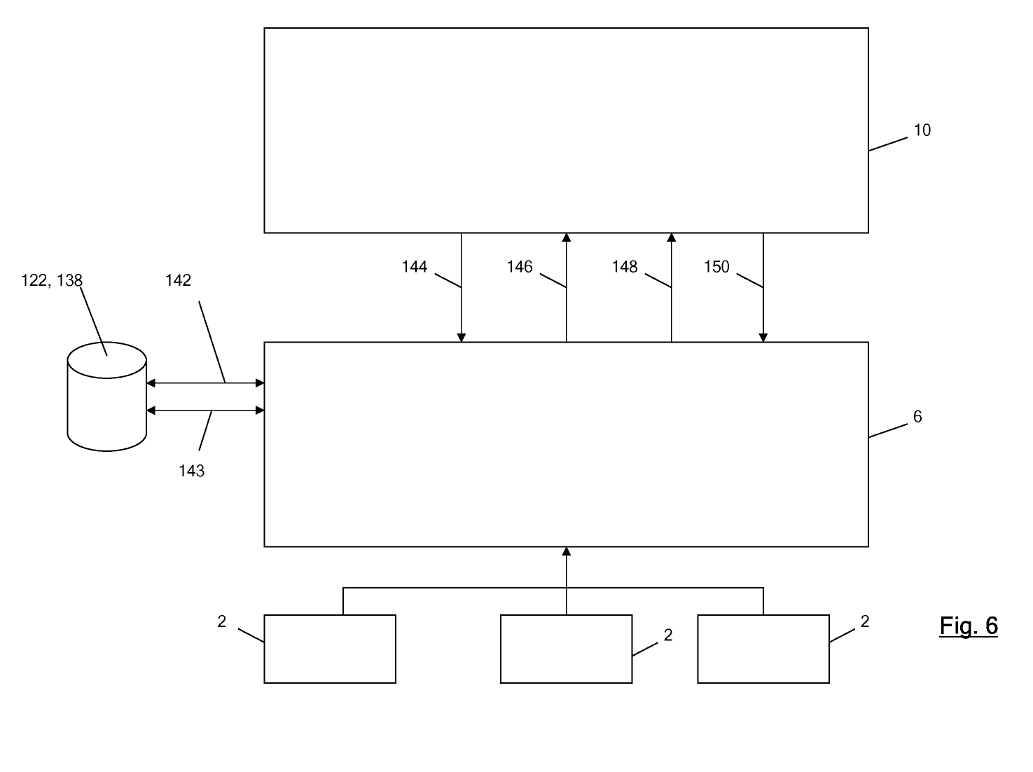

With reference to FIG. 5, the event engine includes an event handling module 130 which receives event data records (functioning as the processed event data records concerning selected electronic tag reading events) from the filter module of the or each edge engine. The event handling module also receives metrics concerning the selectivity of filters from each edge engine. The selectivity information concerns both active and inactive selections. Event data records are forwarded to a complex event processing engine 132 which carries out the remaining computing steps required to process the received event data records. The event handling module may also transmit configuration data to the complex event processing engine where appropriate, depending on the received metrics.

The event handling module transmits statistical information (such as the selectivity of one or more filters) to a control module 134. The control module also receives statistical information concerning the current processing load of the complex event processing engine from a statistical module 136. The statistical module is operable to predict future loads, for example, the predicted rate of receipt of event data records by the edge engines or event engine, or the predicted rate of receipt of event data records fulfilling one or more queries.

A further database 138 stores data and provides a mechanism for the complex event processing engine to retrieve data requested in Event Query Language (EQL). The engine manager graphic user interface 118 is operable to transmit queries received in EQL to a query analyst module 140 which converts queries received in EQL into SQL. The resulting SQL may correspond to a subset of the EQL query from which it is derived.

In use, event data records are received by the edge engines, translated, filtered and forwarded to the complex event processing engine via the event engine event handling module on a continuous basis. In order to provide practical information relevant to the controller or users of the system, queries are submitted by a user through the engine manager graphic user interface. The queries are translated from EQL to SQL by the query analyst module. In this example, the resulting queries function as filter definitions and are transmitted to the edge engines. The edge engines receive the queries and propose the SQL queries to the databases 138, 114 and use the data returned by the query to create lists of identifiers of electronic tags, or people or objects associated with electronic tags, for use in subsequent filtering. The lists of identifiers may include an identifier of, or of a person or object associated with, each electronic tag which could fulfill the respective query.

For example, in an example application the event processing apparatus is used to monitor the location of people (such as passengers and/or staff) and objects (such as baggage) in an airport. The person or object is known to have a tag with a given unique identifier associated with them. For example, in the case of the person they may be carrying a ticket or boarding card containing an RFID with a unique identifier matched up to the individual person when they checked in. In the case of an object, the object may have an RFID having a known unique identifier embedded therein or included in an attached tag. The relationship between the identifier of the passenger and the identifier of the RFID is stored in the database 138, as well as additional data which might be required to determine whether data concerning that passenger might be required to respond to the SQL query. External databases 114 might also be queried. The retrieved relationships between identifiers of passengers and identifiers of RFIDs are examples of translation data.

The engine manager graphic user interface enables an airport manager to specify a query. An example query in EQL might be:

SELECT p.name

FROM tagged Passenger.win:time(3 hour) as t,

sql: MyCustomerDB

[select p.id from Passenger p where p.id=${t.pid} AND p.nationality=‘British’]”

This EQL statement joins an event stream consisting of taggedPassenger events with the results of an SQL query against the database named MyCustomerDB and the table Passenger. The query should return the names of passengers (p.name) who have been identified in the last three hours, who are identified whose nationality, identified in the table Passenger has the value ‘British’.

The query analyst module might translate this EQL query into SQL as follows:

SELECT p.id

FROM Passenger p

WHERE p.nationality=‘British’

The control module can determine from the database MyCustomerDB and the table Passenger that only a subset of passengers, identified by their identifier, p.id, might fulfil the original query. In this example, only passengers who nationality is recorded as British could fulfil the original query and so the control module might define a filter by creating a list of the identifiers, p.id, of all passengers recorded as having the nationality ‘British’.

Thus, in this example embodiment, the filter definitions which are transmitted to the edge engines in the form of SQL queries are posed to databases to obtain a list of passenger identifiers, p.id, of passengers who are associated with electronic tags which may be the subject of event data records that are required to respond to the original EQL query. The translation modules in the edge engines read the unique identifier of the tag which each received event data records concerns and insert the passenger identifier, p.id, of the passenger which the identified tag is known to concern using translation data comprising a table linking unique tag identifiers to passenger identifiers. The filter module then refers to the inserted passenger identifiers and compares these with the lists of identifiers associated with currently active filters.

Thus, the task of processing the selection generator within the EQL query (and the corresponding SQL query) has effectively been pushed out to the edge engines which, when the resulting filter is active, will allow through event data records which fulfill the EQL and SQL selection operators. The evaluation of one or more operators other than selection operators may also be pushed out the edge engines.

The data flow between the event engines, an edge engine and electronic tag readers is summarised in FIG. 6. A single edge engine is shown for clarity but it will be understood that more than one edge engines will typically be provided with similar data flows between each edge engine and the event engine.

Filter definitions 144 are transmitted from the event engine to the edge engines, as required. Filter definitions may, for example, be transmitted after a new query has been entered by a user. Lists of identifiers associated with filter definitions are obtained by querying 142 external databases 122, 138. Filter definitions may require translation data in order to be interpreted and applied, for example, tables linking tag identifiers, t.id, with passenger identifiers p.id. In this example, the edge engines obtain any translation data which is necessary to verify whether a received event data record meets one or more received filter definitions by way of further queries 143 of the external databases.

During operation, processed electronic tag reading event data records are transmitted 146 from the edge engines to the event engine, with substantially greater frequency than filter definitions are transmitted from the event engine to the edge engines. Periodically, metrics concerning the selectivity of previously transmitted filter definitions are transmitted 148 to the event engine. The metrics are taken into account by the control module and statistical module of the event engine and the event engine transmits 150 filter control signals to activate or deactivate previously transmitted filter definitions responsive to current or predicted load.

In an example embodiment, the statistical module determines whether individual filters should be active or inactive taking into account the current and predicted future rate of receipt of event data records fulfilling the definition of each filter, the average size of received event data records, the average amount of CPU usage required to processed a received event data record, the current rate of event engine CPU usage, and the amount of free RAM memory currently available to the event engine. As a result of this procedure the event processing apparatus can carry out load shedding to receive only event data records concerning electronic tag reading events which fulfill a subset of available filter definitions, thereby enabling the apparatus to better cope with fluctuating loads.

In the illustrated example, filter definitions are transmitted to the edge engines in the form of SQL queries which are parsed and posed to databases to prepare the lists of identifiers. In an alternative embodiment, the event engine poses the SQL queries to databases to obtain corresponding lists of identifiers, and the filter definitions comprise the corresponding lists of identifiers. The identifiers may be identifiers of electronic tags, in which case the edge engines will be able to carry out the filtering process without requiring identifiers introduced using translation data. However, in embodiments where the filter definitions comprise one or more lists of identifiers, the identifiers which are transmitted to the edge engines as filter definitions may be identifiers of people or objects associated with electronic tags. In this case, translation data will be required to enable the translation module to include the identifiers of people or objects required by the filter module to determine whether events should be selected for forwarding to the edge engine. The translation data may be obtained by the edge engines querying databases or the event engine may query databases and transmit the translation data to the edge engines, either along with, or separately to, the corresponding filter definition.

Accordingly, the invention has provided event processing apparatus which enables complex event processing methods to be carried out on electronic tag reading event data records receive from different types of electronic tag reader.

In some implementations, the edge engines may forward all data records to the event engine when the rate of receipt of electronic tag reading event data records is within the processing capability of the event engine. However, when the rate of receipt of event data records approaches the processing capability of the event engine, the apparatus may carry out load shedding, by switching on filters, to restrict the rate of receipt of electronic tag reading event data records by the event engine to avoid overloading at times when the rate of tag reads exceeds, or may shortly exceed, the maximum rate at which data records can be processed by the event engine. Furthermore, the apparatus can provide a response to received queries and can amend the active selection criteria used dynamically in response to received queries. The use of translation modules in the edge engines enables basic data processing tasks, which can be readily accomplished, for example using look-up tables, to be carried out before event data records are received by the event engine which will carry out the most complex data processing tasks, thereby delegating some of the processing load to the edge engines. The translation step may avoid duplication of data processing in embodiments where translation introduces identifiers which are required both to facilitate subsequent processing by the event engine and filtering by the edge engines.

In some embodiments, the event processing apparatus may respond to the receipt of very high volumes of event data records by causing the edge engines to select only a proportion of received event data records which meet one or more active selection criteria. Provided that the event engine knows the proportion of received event data records which have been selected, an estimate of the number of event data records which fulfill a query can be calculated. This enables numerical estimates to provided in circumstances where the volume of received event data records may exceed the processing capacity of the event engine even with load shedding.

One skilled in the art will appreciate that although event data record processing has been described herein as being carried out by processors executing program code, some or all of the event data record processing carried out by individual components of the event processing apparatus, such as the electronic tag readers, edge engines and event engine, may be carried out by appropriate electronic circuitry, such as application-specific integrated circuits (ASICs).

Further modifications and variations will be apparent to one skilled in the art.

1. Event processing apparatus for processing electronic tag reading events, the apparatus comprising a first event processing module and one or more second event processing modules, the or each second event processing module being operable to receive event data records concerning electronic tag reading events from electronic tag readers, and to transmit to the first event processing module processed event data records concerning selected electronic tag reading events.

2. Event processing apparatus according to claim 1, wherein the or each second event processing module is operable to transmit processed event data records concerning electronic tag reading events selected according to one or more active selection criteria, which one or more said active selection criteria are changeable over time.

3. Event processing apparatus according to claim 1, wherein the event processing apparatus comprises a filter control module and the filter control module is operable to determine some or all of the active selection criteria taking into account a current or predicted future load of electronic tag reading events.

4. Event processing apparatus according to claim 3, wherein the current or predicted future load of electronic tag reading events taken into account by the filter control module is one or more of a group comprising: the current rate of receipt of event data records at one or more second event processing modules, the current rate of receipt of processed event data records at the first event processing module, a predicted future rate of receipt of event data records at one or more of the second event processing modules, and a predicted future rate of receipt of processed event data records at the first event processing module.

5. Event processing apparatus according to claim 3, wherein the filter control module predicts the future load of electronic tag reading events taking into account statistics of historical loads of electronic tag reading events.

6. Event processing apparatus according to claim 3, wherein the filter control module is operable to transmit filter control signals to one or more said second event processing modules, and the or each said second event processing module is operable to vary the active selection criteria used to select electronic tag reading events responsive to received filter control signals.

7. Event processing apparatus according to claim 3, wherein the filter control module is operable to transmit filter definitions to one or more said second event processing modules.

8. Event processing apparatus according to claim 7, wherein the filter control module is operable to transmit filter definitions to the one or more said second event processing modules and to subsequently transmit filter control signals to the one or more said second event processing modules, the said filter control signals being indicative that one or more filter criteria determined by a previously transmitted filter definition should be activated or deactivated, wherein the or each second event processing module is operable to include one or more criteria determined by a previously received filter definition in the one or more active selection criteria, or to remove one or more criteria determined by a previously received filter definition from the one or more active selection criteria, responsive to a filter control signal indicating that one or more filter criteria determined by the respective previously transmitted filter definition should be activated or deactivated, as appropriate.

9. Event processing apparatus according to claim 3, wherein the one or more second event processing modules are operable to transmit filter matching data related to the proportion of received event data records which match the one or more criteria determined by a previously received filter definition.

10. Event processing apparatus according to claim 9, wherein the transmitted filter matching data is related to either or both the selectivity or rate of receipt of event data records which match the one or more criteria determined by a previously received filter definition.

11. Event processing apparatus according to claim 9, wherein the one or more second event processing modules are operable to transmit said filter matching data in connection with either or both filter definitions which are currently active and filter definitions which are currently inactive.

12. Event processing apparatus according to claim 3, wherein the event processing apparatus is operable to receive and respond to queries concerning electronic tag reading events or data derived from electronic tag reading events processed by the event processing apparatus.

13. Event processing apparatus according to claim 12, wherein the filter control module is operable to transmit filter control signals to one or more second event processing modules responsive to receipt of a query by the event processing apparatus.

14. Event processing apparatus according to claim 3, wherein the or each second event processing module is operable to select an electronic tag reading event responsive to an identifier included in the received event data record concerning the respective electronic tag reading event.

15. Event processing apparatus according to claim 1, wherein at least some of the processed event data records which are transmitted to the first event processing module are selected received event data records which are unmodified or changed only in terms of format.

16. Event processing apparatus according to claim 1, wherein the output processed event data records are modified received event data records which include different data to the received event data records and the or each, second event processing module comprises an event record data modification module.

17. Event processing apparatus according to claim 16, wherein the event record data modification module is in communication with one or more databases including data relevant to electronic tags, the or each second event processing module comprises a translation module operable to modify the event record data, which translation module is operable to determine from the identifier of an electronic tag included in the event record data, an identifier of a person or object with which the electronic tag is associated, and to add an identifier or the person or object to the event record data.

18. Event processing apparatus according to claim 1, wherein the one or more second event processing modules select electronic tag reading events after modification, according to one or more criteria which require data introduced into the event data records during modification.

19. A method of processing electronic tag reading events, the method comprising the steps of receiving event data records concerning electronic tag reading event at a second event processing module from electronic tag readers, and transmitting processed event data records concerning selected electronic tag reading events to a first event processing module.

20. A method of processing electronic tag reading events according to claim 19, wherein the or each second event processing module selects electronic tag reading events according to one or more active selection criteria, which one or more said active selection criteria are changeable over time, and transmits processed event data records concerning the selected electronic tag reading events to the first event processing module.

21. A method of processing electronic tag reading events according to claim 19, wherein the event processing apparatus comprises a filter control module and the filter control module determines some or all of the active selection criteria taking into account a current or predicted future load of electronic tag reading events.

22. A method of processing electronic tag reading events according to claim 20, wherein the current or predicted future load of electronic tag reading events taken into account by the filter control module is one or more of a group comprising: the current rate of receipt of event data records at one or more second event processing modules, the current rate of receipt of processed event data records at the first event processing module, a predicted future rate of receipt of event data records at one or more of the second event processing modules, a predicted future rate of receipt of processed event data records at the first event processing module; the size of reduced event data records; and the selectivity of one or more of the active selection criteria.

23. A method of processing electronic tag reading events according to claim 21, wherein the filter control module predicts the future load of electronic tag reading event taking into account statistics of historical loads of electronic tag reading events.

24. A method of processing electronic tag reading events according to claim 21, wherein the filter control module transmits filter control signals to one or more said second event processing modules, and the or each said second event processing module varies the active selection criteria used to select electronic tag reading events responsive to received filter control signals.

25. A method of processing electronic tag reading events according to claim 21, wherein the filter control module transmits filter definitions to one or more said second event processing modules.

26. A method of processing electronic tag reading events according to claim 25, wherein the filter control module transmits filter definitions to the one or more said second event processing modules and subsequently transmits filter control signals to the one or more said second event processing modules, the said filter control signals being indicative that one or more filter criteria determined by a previously transmitted filter definition should be activated or deactivated, wherein the or each second event processing module includes one or more criteria determined by a previously received filter definition in the one or more active selection criteria, or removes one or more criteria determined by a previously received filter definition from the one or more active selection criteria, responsive to a filter control signal indicating that one or more filter criteria determined by the respective previously transmitted filter definition should be activated or deactivated, as appropriate.

27. A method of processing electronic tag reading events according to claim 21, wherein the one or more second event processing modules transmit filter matching data related to the proportion of received event data records which match the one or more criteria determined by a previously received filter definition

28. A method of processing electronic tag reading events according to claim 27, wherein the transmitted filter matching data is related to either or both the selectivity or rate of receipt of event data records which match the one or more criteria determined by a previously received filter definition.

29. A method of processing electronic tag reading events according to claim 27, wherein the one or more second event processing modules transmit said filter matching data in connection with either or both filter definitions which are currently active and filter definitions which are currently inactive.

30. A method of processing electronic tag reading events according to claim 21, wherein the event processing apparatus receives and responds to queries concerning electronic tag reading events or data derived from electronic tag reading events processed by the event processing apparatus.

31. A method of processing electronic tag reading events according to claim 30, wherein the filter control module transmits filter control signals to one or more second event processing modules responsive to receipt of a query by the event processing apparatus.

32. A method of processing electronic tag reading events according to claim 21, wherein the or each second event processing module selects an electronic tag reading event responsive to an identifier included in the received event data record concerning the respective electronic tag reading event.

33. A method of processing electronic tag reading events according to claim 19, wherein at least some of the processed event data records which are transmitted to the first event processing module are selected received event data records which are unmodified or changed only in terms of format.

34. A method of processing electronic tag reading events according to claim 19, wherein the output processed event data records are modified received event data records which include different data to the received event data records and the or each second event processing module comprises an event data record modification module.

35. A method of processing electronic tag reading events according to claim 33, wherein the event data record modification module is in communication with one or more databases including data relevant to electronic tags, the or each event data record modification module comprises or consists of an event data record translation module operable to modify received event data records, which event data translation module is operable to determine from the identifier of an electronic tag included in the event record data, an identifier of a person or object with which the electronic tag is associated, and to include an identifier of the person or object to the event record data.

36. A method of processing electronic tag reading events according to claim 33, wherein the one or more second event processing modules select electronic tag reading events after modification, according to one or more criteria which require data introduced into the event data records during modification.

37. Computer program code which, when executed on one or more computers, causes the one or more computers to function as the event processing apparatus according to claim 1.

38. A computer readable storage medium storing computer program code according to claim 37.
